(19) United States
(12) Patent Application Publication
(10) Pub. No.: US 2026/0296184 A1
(43) Pub. Date: Oct. 1, 2026

(54) Off-Road Vehicle

(71) Applicant: Zhejiang CFMOTO Power Co., Ltd., Hangzhou (CN)

(72) Inventors: Xiliang Cai, Hangzhou (CN); Wenbing Duan, Hangzhou (CN); Fuying Cheng, Hangzhou (CN); Yi Hua, Hangzhou (CN); Qingsong Chen, Hangzhou (CN)

(21) Appl. No.: 19/329,489

(22) Filed: Sep. 15, 2025

(30) Foreign Application Priority Data
Mar. 28, 2025 (CN) 202510388303.3
Mar. 28, 2025 (CN) 202510397884.7
Mar. 28, 2025 (CN) 202520580327.4

(51) Int. Cl. B60K 17/346; B60K 17/22

(52) U.S. Cl. CPC B60K 17/3467; B60K 17/22; B60Y 2200/20

(57) ABSTRACT

An off-road vehicle with a four-wheel drive mode and side-by-side seating has a prime mover assembly with an engine, CVT and gear assembly. The engine includes a plurality of cylinders driving a longitudinally-extending crankshaft, all on one right or left side of the longitudinal mid-plane. The CVT is positioned either in front of or behind the engine, extending across the longitudinal mid-plane. The gear assembly is positioned either in front of or behind the CVT, with its centroid positioned on the opposite side of the longitudinal mid-plane as the engine. A main front drive shaft extends at least partially under the side-by-side seating area, but neither the main front drive shaft nor any other of the drive line components delivering torque from the gear assembly to the front differential extend under the engine in plan view.

### RELATED APPLICATION INFORMATION

The present application claims the benefits of priority to Chinese Patent Application No. 202510388303.3, filed with the Chinese Patent Office on Mar. 28, 2025, to Chinese Patent Application No. 202520580327.4, filed with the Chinese Patent Office on Mar. 28, 2025, and to Chinese Patent Application No. 202510397884.7, filed with the Chinese Patent Office on Mar. 28, 2025. The entire contents of the above-referenced applications are incorporated herein by reference.

### FIELD OF THE DISCLOSURE

The present application relates to the field of vehicles, and particularly to an off-road vehicle.

### BACKGROUND OF THE DISCLOSURE

The present application relates to the field of vehicles, and particularly to an off-road vehicle (ATV). Off-road vehicles are a type of vehicle that can travel on various complex terrains, such as mountains, deserts, muds, and the like and are widely used in agriculture, forestry, military, and leisure and entertainment fields. Existing off-road vehicles typically use traditional machine driven system, including components such as clutches, gearboxes, and drive shaft. Although these drive trains can meet the driving needs of off-road vehicles to some extent, there are still some significant issues.

The drive train of traditional off-road vehicles is complex and occupies a large space.

### SUMMARY OF THE INVENTION

In order to address the shortcomings of existing vehicles, the purpose of the present application is to provide an off-road vehicle with a more compact power train.

To achieve the above objectives, the present application adopts the following technical solution.

An off-road vehicle includes a frame, a side-by-side seating area, a plurality of wheels, an engine, a continuously variable transmission (CVT), a gear assembly, and a drive train. The side-by-side seating area is supported by the frame. The plurality of wheels support the frame through a suspension, with the plurality of wheels including at least two front wheels and at least two rear wheels. The frame and the plurality of wheels define a longitudinal mid-plane of the off-road vehicle. The engine is supported by the frame and includes a plurality of cylinders driving a longitudinally-extending crankshaft. The continuously variable transmission (CVT) is connected to the engine and receives torque from the crankshaft, with the CVT being positioned either in front of or behind the engine. The gear assembly is connected to the CVT and receives torque from the CVT, with the gear assembly being positioned either in front of or behind the CVT. The drive train delivers torque from the gear assembly to the front and rear wheels at least while the off-road vehicle is in the four-wheel drive mode. The drive train is supported by the frame and includes a front differential, a rear differential and one or more drive line components (including a main front drive shaft) delivering torque longitudinally from the gear assembly to the front differential. The front differential extends across the longitudinal mid-plane forward of the engine, and is able to provide torque to the front wheels for locomotion of the off-road vehicle at least while in the four-wheel drive mode. The rear differential extends across the longitudinal mid-plane at least partially rearward of the engine, and is able to provide torque to the rear wheels for locomotion of the off-road vehicle at least while in the four-wheel drive mode. The main front drive shaft extends at least partially under the side-by-side seating area. Neither the main front drive shaft nor any other of the drive line components delivering torque from the gear assembly to the front differential extend under the engine in plan view.

In another aspect, the engine is positioned entirely on a right or left side of the longitudinal mid-plane, while the CVT extends across the longitudinal mid-plane. The gear assembly has a gear assembly centroid positioned on the opposite side of the longitudinal mid-plane as the engine.

### BRIEF DESCRIPTION OF THE DRAWINGS

FIG. 1 is a front left perspective view of a preferred off-road vehicle according to the present invention;

FIG. 2 is a front right perspective view of the frame, wheels, preferred prime mover assembly and preferred drive train of the off-road vehicle of FIG. 1;

FIG. 3 is a plan view of the layout of the wheels, prime mover assembly, drive train, fuel tank and battery of the off-road vehicle of FIGS. 1 and 2;

FIG. 4 is a schematic plan view of the prime mover assembly and a portion of the drive train of FIG. 3;

FIG. 5 is an end view of the engine of the off-road vehicle of FIGS. 1-4;

FIG. 6 is a cross-sectional view of the CVT of the off-road vehicle of FIGS. 1-5, taken along cut lines 6-6 in FIG. 3;

FIG. 7 is a plan view of a first alternative layout of the wheels, prime mover assembly, drive train, fuel tank and battery for the off-road vehicle of FIG. 1;

FIG. 8 is a schematic plan view of the prime mover assembly and a portion of the drive train of FIG. 7;

FIG. 9 is a plan view of a second alternative layout of the wheels, prime mover assembly, drive train, fuel tank and battery for the off-road vehicle of FIG. 1; and

FIG. 10 is a schematic plan view of the prime mover assembly and a portion of the drive train of FIG. 9.

### DETAILED DESCRIPTION

For better understanding of the above objects, features and advantages of the present invention, the embodiments of the present disclosure will be described in detail below with reference to the accompanying drawings.

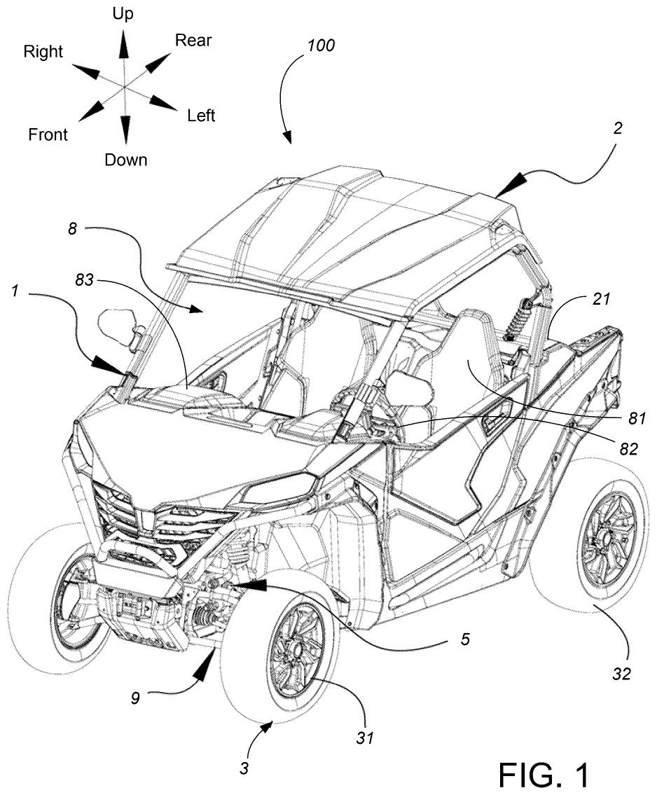

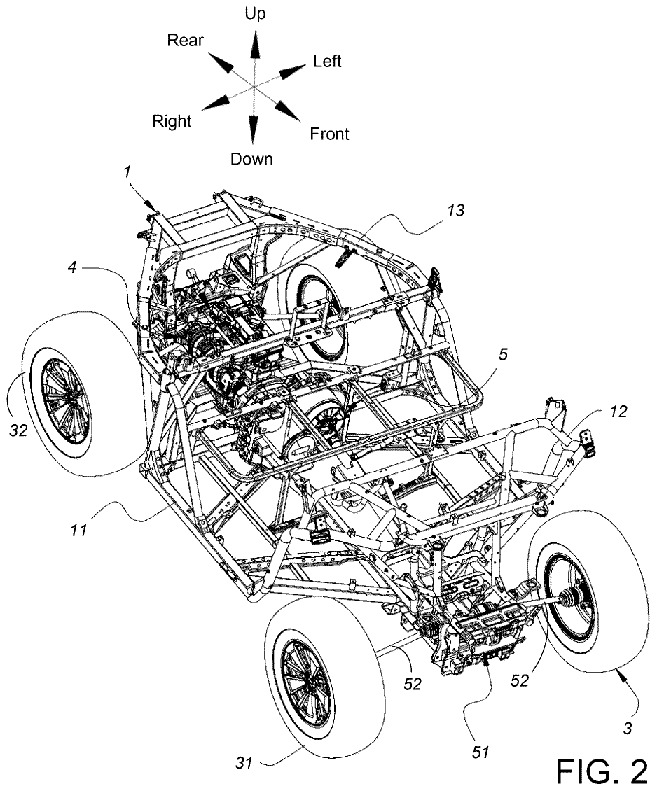

As shown in FIGS. 1 and 2, an off-road vehicle 100 includes a frame 1, a vehicle cover 2, a plurality of wheels 3, a prime mover assembly 4, a drive train 5, a fuel system 6, an electrical system 7, and a cockpit or seating area 8. The vehicle cover 2 is positioned at least partially above the frame 1 and fixedly connected to the frame 1, to cover components such as of the prime mover assembly 4, drive train 5, fuel system 6 and electrical system 7. The plurality of wheels 3 include front wheels 31 and rear wheels 32 which are positioned at least partially below the frame 1 and support the frame 1 through a suspension 9. As used herein, the term “wheels” includes relatively low pressure tires adapted for off road travel. The prime mover assembly 4 is supported by the frame 1 and coupled to the plurality of wheels 3 through the drive train 5, such that a driving force generated by the prime mover assembly 4 is transmitted to the plurality of wheels 3 for locomotion of the off-road vehicle 100. The fuel system 6 provides fuel such as gasoline to the prime mover assembly 4. The electrical system 7 provides electric power (typically primarily at nominally 12 volts DC) to the electronic components of the off-road vehicle 100. The cockpit 8 is supported by the frame 1 between the front wheels 31 and the rear wheels 32, including side-by-side seating 81 for at least a driver and optionally a passenger.

The general orientations of front, rear, up (upper), down (lower), left and right for the off-road 100 are called out in FIGS. 1-10 for better understanding of the drawings. In the present application, a length or longitudinal direction of the off-road 100 refers to a direction from front to back as shown in FIG. 1; a width (lateral or transverse) direction of the off-road vehicle 100 refers to a direction from left to right as shown in FIG. 1, and a height direction of the off-road vehicle 100 refers to a direction from down to up as shown in FIG. 1, all assuming the vehicle 100 has its wheels 3 on flat ground. The frame 1 and the plurality of wheels 3 jointly define a longitudinal mid-plane 101 of the off-road vehicle 100, which is a vertical plane spaced equally between the right and left extents of the frame 1 and/or wheels 3.

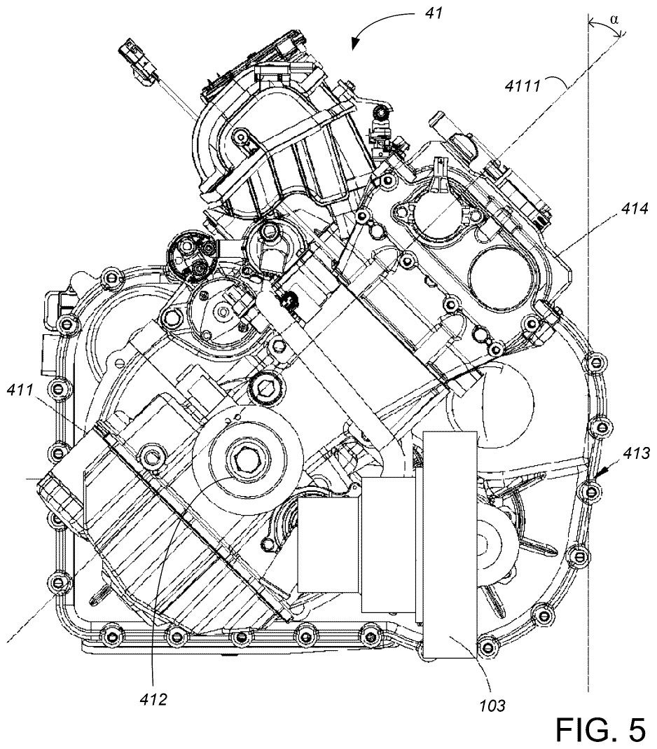

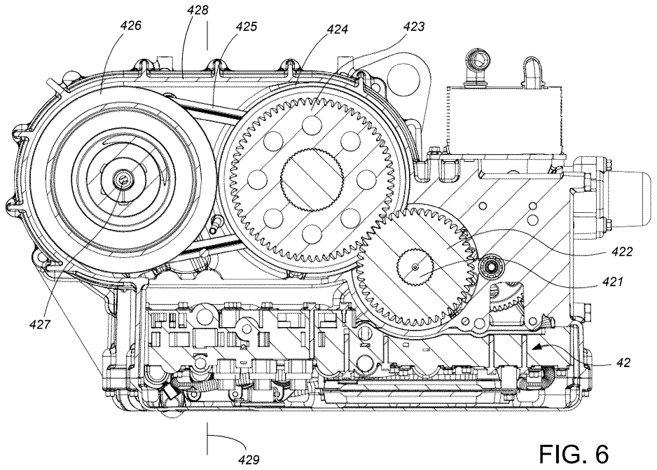

The prime mover assembly 4 of a first embodiment is shown in FIGS. 2-4, with portions of the prime mover assembly 4 further shown in FIGS. 5 and 6. The prime mover assembly 4 includes an engine 41, a continuously variable transmission (CVT) 42 and a gear assembly 43, all of which are jointly pre-assembled and during manufacture of the vehicle 100 preferably mounted into the vehicle frame 1 as a unit. The engine 41 provides locomotive power for the off-road vehicle 100. The CVT 42 is used to change the speed and torque output of the engine 41, thereby providing different transmission ratios to adapt to different driving conditions. Such as through gears of “Park”, “Reverse”, “Neutral”, “Drive”, “Low” and “High”, the gear assembly 43 allows shifting of the rotational direction and further converts high rotational speed low torque power into low rotational speed high torque output. The CVT 42 is connected to the engine 41 and the gear assembly 43 respectively, transmitting the torque generated by the engine 41 to the gear assembly 43 after a certain speed ratio change.

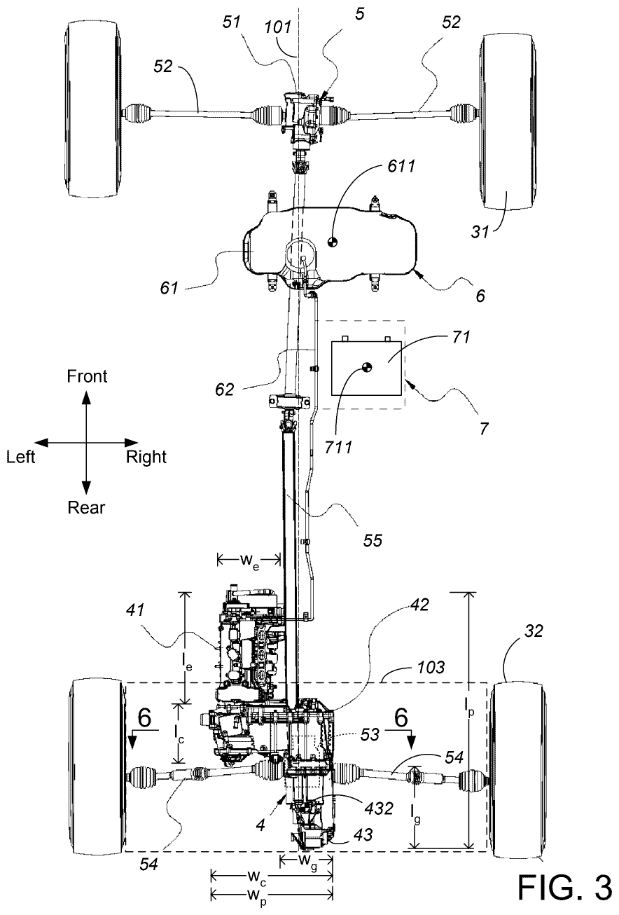

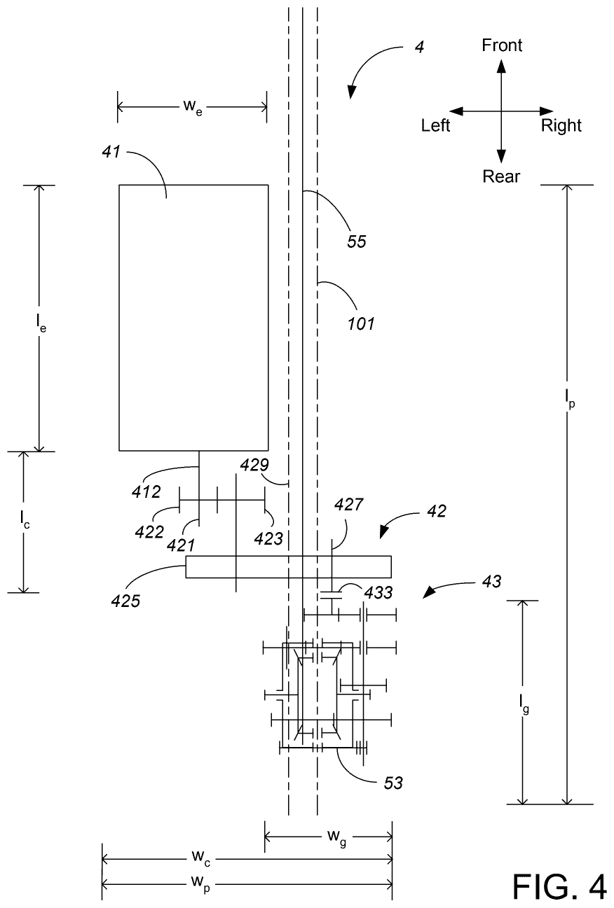

The length lₑ of the engine 41, the width wₑ of the engine 41, the length l_{c} of the CVT 42, the width w_{c} of the CVT 42, the length l_{g} of the gear assembly 43, and the width w_{g} of the gear assembly 43 are all called out in FIGS. 3 and 4. With the engine 41, CVT 42 and gear assembly 43 all assembled into the prime mover assembly 4, the overall length lₚ of the prime mover assembly 4 and overall width wₚ of the prime mover assembly 4 are also called out in FIGS. 3 and 4. In the preferred embodiments, the overall width wₚ of the prime mover assembly 4 is substantially equal to the width w_{c} of the CVT 42.

The off-road vehicle 100 is capable of a four-wheel drive mode, in which torque is transferred to both the front wheels 31 and the rear wheels 32 for the vehicle 100 to move. The drive train 5 thus includes at least a front differential 51 delivering torque to the front wheels 31 through two front half shafts 52, and a rear differential 53 delivering torque to the rear wheels 32 through two rear half shafts 54. So as to have substantially equal lengths of right and left half shafts 52, 54 and relatively balanced torque distribution right to left in the vehicle 100, the front differential 51 and the rear differential 53 are both positioned substantially at the longitudinal mid-plane 101 of the off-road vehicle 100. The drive train 5 further includes a main drive shaft 55 delivering torque longitudinally in the vehicle 100, from the prime mover assembly 4 under the seating area 8 to one of the differentials 51, 53. In the preferred embodiments, the prime mover assembly 4 is positioned behind the cockpit 8, so the main drive shaft 55 is a front drive shaft coupling the gear assembly 43 to the front differential 51. The rear differential 53 could be coupled to the gear assembly 43 through a rear drive shaft (not shown), but more preferably is directly connected to the gear assembly 43, with a housing 531 of the rear differential 53 mounted on a housing 431 of the gear assembly 43.

FIG. 2 shows a preferred frame 1 for the off-road vehicle 100. The frame 1 includes a plurality of base rails 11 extending longitudinally and collectively defining a bottom of the frame 1. A front upright section 12 of the frame 1 extends upwardly from the bottom of the frame 1 in front of the cockpit 8. The front upright section 12 is used to mount a steering assembly 82 and a dashboard 83 of the off-road vehicle 100 at the front of the cockpit 8. A rear upright section 13 of the frame 1 extends upwardly from the bottom of the frame 1 behind the cockpit 8. The rear upright section 13 is used to mount portions of the vehicle cover 2 such as a cargo area 21 over the prime mover assembly 4.

As best shown in FIG. 3, the engine 41 is preferably a three cylinder engine with the three cylinders 411 arranged longitudinally in line. As called out in FIG. 4, the crankshaft 412 of the engine 41 extends longitudinally, substantially parallel to the longitudinal mid-plane 101. With the engine 41 being longitudinally mounted, the crankshaft 412 of the engine 41 is substantially parallel to the main drive shaft 55, which eliminates space required for power transmission components (bevel gears, etc., not shown) otherwise used to turn power transmission by 90°, reducing the overall space required by the prime mover assembly 4 and/or drive train 5.

The CVT 42 in this embodiment is positioned behind (rearwardly of) the engine 41, and the gear assembly 43 in this embodiment is positioned behind the CVT 42. The entirety of the engine 41 is positioned to the left of the longitudinal mid-plane 101, the CVT 42 extends across the longitudinal mid-plane 101, and the gear assembly 43 is arranged substantially to the right of the longitudinal mid-plane 101, i.e., has its gear assembly centroid 432 on the opposite (right, rather than left) side of the longitudinal mid-plane 101 as the engine 41. With the gear assembly 43 positioned behind the CVT 42, the main front drive shaft 55 extends under the CVT 42.

With the gear assembly centroid 432 on the opposite (right, rather than left) side of the longitudinal mid-plane 101 as the engine 41, neither the main front drive shaft 55 nor any other of the drive line components delivering torque from the gear assembly 43 to the front differential 51 extend under the engine 41. This allows the engine 41 to be positioned relatively lower in the vehicle 100, and/or the main drive shaft 55 to be positioned relatively higher in the vehicle 100, to maintain sufficient ground clearance for the off-road vehicle 100 while still keeping weight low in the vehicle 100 for better handling.

The engine 41 is a relatively heavy component of the off-road vehicle 100. With the engine 41 positioned entirely on one side of the longitudinal mid-plane 101, the weight of the engine 41 may cause the center of gravity of the off-road vehicle 100 to shift to that one side, which may lead to the loss of stability of the off-road vehicle 100 during driving. While positioning the gear assembly centroid 432 on the opposite side of the longitudinal mid-plane 101 as the engine 41 helps somewhat, further weight balancing may be advantageous.

FIG. 3 further shows portions of the fuel system 6 and electrical system 7 of the off-road vehicle 100. The fuel system 6 includes a fuel tank 61 for storing fuel, and a fuel line 62 delivering fuel to the engine 41. The electrical system 7 includes a battery 71. Both the fuel tank 61 (when full) and the battery 71 are relatively heavy components of the off-road vehicle 100. The fuel tank 61 is positioned in front of the seating area 8, with at least a portion of the fuel tank 61 being positioned above the drive shaft 55. The fuel tank 61 preferably extends across the longitudinal mid-plane 101, with a centroid 611 of the fuel tank 61 being positioned on the opposite right or left side of the longitudinal mid-plane 101 as the engine 41, i.e., in this embodiment with the engine 41 positioned on the left side of the longitudinal mid-plane 101, the fuel tank centroid 611 is positioned on the right side of the longitudinal mid-plane 101. The preferred embodiment positions a centroid 711 of the battery 71, and more preferably the entirety of the battery 71, also on the opposite right or left of the longitudinal mid-plane 101 as the engine 41, i.e., in this embodiment with the engine 41 positioned on the left side of the longitudinal mid-plane 101, the entirety of the battery 71 is positioned on the right side of the longitudinal mid-plane 101. Arranging the fuel tank centroid 611 and the battery centroid 711 on the opposite side of the longitudinal mid-plane 101 as the engine 41 can effectively balance the overall center of gravity of the off-road vehicle 100.

Positioning the fuel tank 61 in particular forward of the cockpit 8 helps to evenly distribute weight between the front and rear axles, improving the handling and stability of the off-road vehicle 100. Front to back balancing is particularly important for off-road environments. At the same time, positioning the fuel tank 61 too far forward can increase the risk of fuel tank puncture during frontal collisions, and safety considerations tend to favor keeping the fuel tank 61 toward the center of the vehicle 100. The battery 71 is preferably positioned toward the front of the vehicle 100, but may be within or under the cockpit 8.

FIG. 5 shows an end view of just the engine 41. The engine 41 includes an engine block 413 defining the three cylinder axes 4111, and a cylinder head 414. In some embodiments, the cylinder axes 4111 extend substantially vertically. In other embodiments such as shown in FIG. 5, the engine 41 is mounted with a cylinder axes tilt angle α to vertical. The cylinder axis tilt angle α is preferably in the range from 10 to 55°, which can be with the cylinder head 414 toward the longitudinal mid-plane 101 or with the cylinder head 414 away from the longitudinal mid-plane 101. Tilting the cylinder axes 4111 effectively reduces the height of the engine 41. Further, a component space 102 is defined underneath of portion of the tilted engine 41 between the tilted engine 41 and the base rails 11 of the frame 1, which can be used to accommodate at least some components of the electrical system 7 or other components of the off-road vehicle 100 to improve the spatial adaptability of the engine 41 within the compact framework of the off-road vehicle 100.

The internal structure of the CVT 42 is best shown in FIG. 6. The CVT 42 preferably includes a CVT input shaft 421, a CVT input gear 422, a driving gear 423, a driving pulley 424, a CVT belt 425, a driven pulley 426 and a CVT output shaft 427 all within a CVT housing 428. The CVT input shaft 421 is connected to the crankshaft 412 of the engine 41, preferably through a spline (not shown) to achieve torque transmission. The CVT input gear 422 is coaxially fixed to the CVT input shaft 421 and meshed with the driving gear 423. One side of the driving pulley 424 is fixed with the driving gear 423 to transmit the torque of the CVT input shaft 421 to the driving pulley 424. The CVT belt 425 is entrained about both the driving pulley 424 and the driven pulley 426 at variable diameters on each, so the driving pulley 424 transmits torque to the driven pulley 426 while the rotational speed of the driven pulley 426 can change relative to the rotational speed of the driving pulley 424. Both the rotational axis of the driving pulley 424 and the rotational axis of the driven pulley 426 extend parallel to the rotational axis of the crankshaft 412, parallel to the longitudinal mid-plane 101. In some embodiments, the CVT belt 425 is a steel belt, which has the advantages of being lightweight, small in size, and simple. In other embodiments, the CVT belt 425 is a rubber belt, which is lower in cost. In still other embodiments, the CVT belt 425 is replaced by a steel chain, which has better transmission efficiency and high load-bearing capacity. The CVT output shaft 427 is coaxially fixed to the driven pulley 426, and is coupled to the input end of the gear assembly 43 in a transmission mode such as through a clutch 433 when the off-road vehicle 100 is in gear (other than Park or Neutral). The CVT housing 428 is fixedly connected to the engine block 413. In some alternative embodiments, the housing 428 of the CVT 42 and the housing 431 of the gear assembly 43 are integrally formed.

A CVT mid-plane 429 is defined parallel to the longitudinal mid-plane 101 (and parallel to the rotation axes of the driving pulley 424 and of the driven pulley 426), spaced equally between the driving pulley axis and the driven pulley axis. The CVT mid-plane 429 is on the same left side of the longitudinal mid-plane 101 as the engine 41. Optionally, the entirety of the engine 41 is positioned even further to the left than the CVT mid-plane 429. The gear assembly 43 and the main drive shaft 55 are positioned on the other side, or right side, of the CVT mid-plane 429.

It should be noted that right to left arrangement of the layout of FIGS. 2-4 can alternatively be reversed as a mirror image. That is, the engine 41 can be alternatively be positioned entirely on the right side of the longitudinal mid-plane 101, with the gear assembly centroid 432, the fuel tank centroid 611 and the battery 71 positioned on the left side of the longitudinal mid-plane 101, to result in equivalent weight balancing.

A mount area space 103 is defined as being between the rear wheels 32, behind a front extent of the rear wheels 32 and in front of a rear extent of the rear wheels 32. In this embodiment with the CVT 42 behind the engine 41 and the gear assembly 43 behind the CVT 42, 28 to 80% of the prime mover assembly length lₚ is preferably within the mount area space 103. Positioning 28 to 80% of the prime mover assembly length lₚ within the mount area space 103 leads to better front to back weight balancing of the off-road vehicle 100.

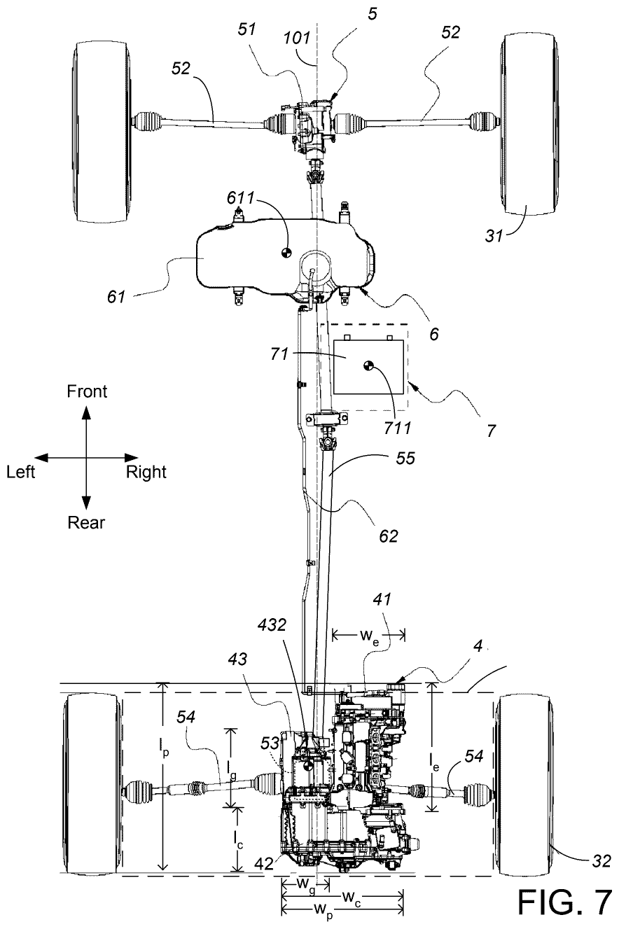

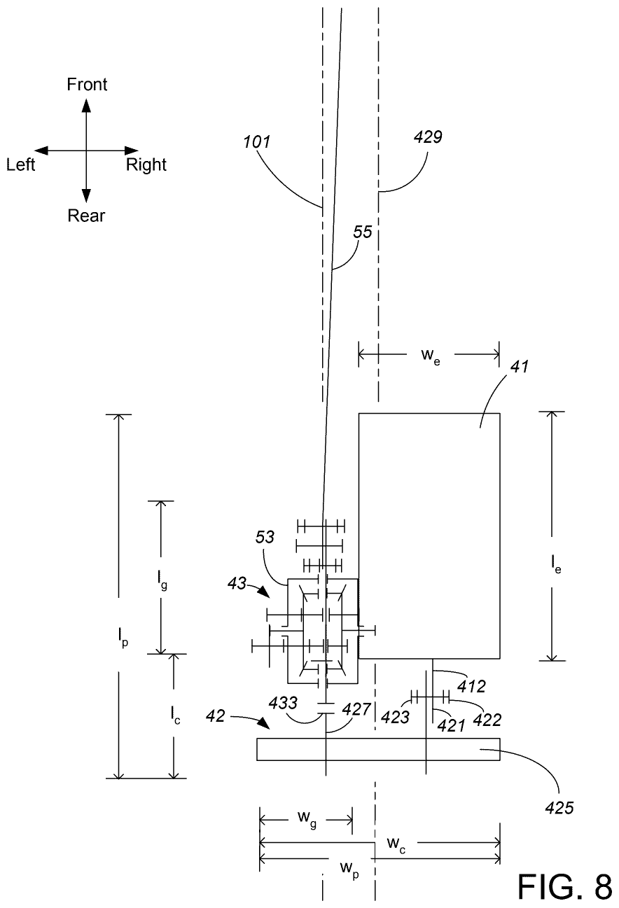

FIGS. 7 and 8 show an alternative layout also in accordance with the present invention. In this embodiment, the engine 41 is positioned entirely to the right of the longitudinal mid-plane 101, the CVT 42 is positioned behind the engine 41, and the gear assembly 43 is positioned in front of the CVT 42 with its centroid 432 to the left of the longitudinal mid-plane 101. Again, the crankshaft 412 of the engine 41 extends longitudinally, with the engine 41 having three cylinders 411 arranged in line. Again, neither the main front drive shaft 55 nor any other of the drive line components delivering torque from the gear assembly 43 to the front differential 51 extend under the engine 41. The gear assembly 43 is positioned substantially above the rear differential 53, with the right rear half shaft 54 extending under the engine 41. While positioning one of the rear half shafts 54 under the engine 41 requires the engine 41 to be raised somewhat to maintain ground clearance like the first embodiment, the right rear half shaft 54 can still be smaller and lower than the main drive shaft 55, so some of the benefits of low engine positioning are maintained. The battery positioning on the right of the longitudinal mid-plane 101 is maintained (avoiding any interference with foot pedals (not shown) or any other driver controls), but the fuel tank 61 is flipped so the centroid 611 of the fuel tank 61 is on the left of the longitudinal mid-plane 101, i.e., on the opposite side of the longitudinal mid-plane 101 as the engine 41. It should be noted that right to left arrangement of the layout of FIGS. 7 and 8 can alternatively be reversed as a mirror image.

This layout of FIGS. 7 and 8 obtains many of the weight balancing and compactness benefits discussed above for the first embodiment, but positions the prime mover assembly 4 as a whole further rearward in the vehicle 100. This layout can optimize the performance of the off-road vehicle 100 in climbing steep slopes while enhancing rear wheel traction and maintaining driving stability. In this embodiment, the engine 41, the CVT 42, and the gear assembly 43 are substantially positioned within the mount area space 103. Further, when the gear assembly 43 and the engine 41 are both in front of or behind the CVT 42, from 40 to 100% of the prime mover assembly length lₚ is within the mount area space 103. Further, placing both the engine 41 and the gear assembly 43 either in front of or behind the CVT 42 shortens the overall length lₚ of the prime mover assembly 4, which can be beneficial for compactness of the off-road vehicle 100.

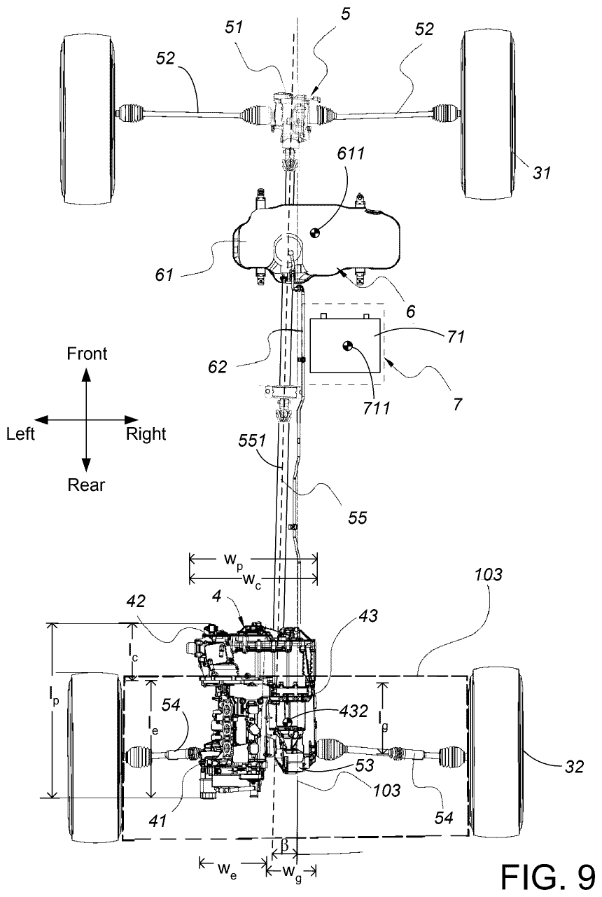

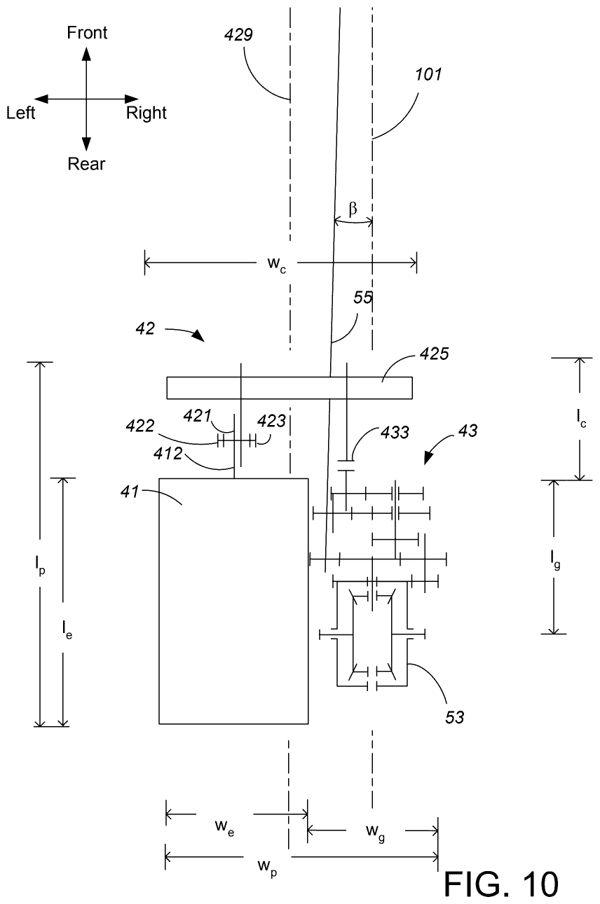

FIGS. 9 and 10 show a show a second alternative layout also in accordance with the present invention. In this embodiment, the engine 41 is positioned entirely to the left of the longitudinal mid-plane 101, the CVT 42 is positioned in front the engine 41, and the gear assembly 43 is positioned behind the CVT 42 with its centroid 432 to the right of the longitudinal mid-plane 101. Again, the crankshaft 412 of the engine 41 extends longitudinally, with the engine 41 having three cylinders 411 arranged in line. Again, neither the main front drive shaft 55 nor any other of the drive line components delivering torque from the gear assembly 43 to the front differential 51 extend under the engine 41. The gear assembly 43 is positioned substantially above the rear differential 53, with the left rear half shaft 54 extending under the engine 41. With the gear assembly 43 positioned behind the CVT 42, the main front drive shaft 55 extends under the CVT 42 like in the first embodiment. The battery positioning on the right of the longitudinal mid-plane 101 is maintained. The centroid 611 of the fuel tank 61 is on the right of the longitudinal mid-plane 101, i.e., on the opposite side of the longitudinal mid-plane 101 as the engine 41. It should be noted that right to left arrangement of the layout of FIGS. 9 and 10 can alternatively be reversed as a mirror image.

FIGS. 9 and 10 also show a drive shaft offset angle β defined between the axis 551 of the main drive shaft 55 and the longitudinal mid-plane 101. The drive shaft offset angle β in this embodiment is preferable in the range from 0 to 15°, more preferably in the range from 2 to 10°. Having a non-zero drive shaft offset angle β allows more flexibility in positioning of the gear assembly 43 to the left or right according to the layout requirements of the vehicle's center of gravity, effectively balancing the center of gravity position of the off-road vehicle 100 and improving its operational stability.

Like the first alternative embodiment, this layout of FIGS. 9 and 10 obtains many of the weight balancing and compactness benefits discussed above for the first embodiment, without positioning the prime mover assembly 4 quite as far rearward in the vehicle 100.

It should be understood that the specific embodiments described herein are only used to explain the present application, but not to limit the present application. The drawings are only some examples or embodiments of the present invention. For those skilled in the art, the present invention can also be applied to other similar situations based on these drawings, but without the need for creative labor. According to the embodiments described herein, all other embodiments obtained by those skilled in the art without creative labor, as well as improvements or transformations can be made based on the above description, are within the scope of protection of the present application.

1. An off-road vehicle having a four wheel drive mode comprising:
a frame;
a side-by-side seating area supported by the frame;
a plurality of wheels supporting the frame through a suspension, the plurality of wheels including at least two front wheels and at least two rear wheels, the frame and the plurality of wheels defining a longitudinal mid-plane of the off-road vehicle;
an engine supported by the frame, the engine comprising a plurality of cylinders driving a longitudinally-extending crankshaft;
a continuously variable transmission (CVT) connected to the engine and receiving torque from the crankshaft, the CVT being positioned in front or behind the engine;
a gear assembly connected to the CVT and receiving torque from the CVT, the gear assembly being positioned in front or behind the CVT; and
a drive train supported by the frame and delivering torque from the gear assembly to the front and rear wheels at least while the off-road vehicle is in the four-wheel drive mode, the drive train comprising:
a front differential extending across the longitudinal mid-plane and able to provide torque to the front wheels for locomotion of the off-road vehicle, the front differential being forward of the engine;
a rear differential extending across the longitudinal mid-plane and able to provide torque to the rear wheels for locomotion of the off-road vehicle, the rear differential being at least partially rearward of the engine; and
one or more drive line components delivering torque longitudinally from the gear assembly to the front differential, the drive line components including a main front drive shaft extending at least partially under the side-by-side seating area;
wherein neither the main front drive shaft nor any other of the drive line components delivering torque from the gear assembly to the front differential extend under the engine in plan view.

2. The off-road vehicle according to claim 1, wherein the engine defines at least one cylinder axis which is inclined relative to the longitudinal mid-plane.

3. The off-road vehicle according to claim 2, wherein the engine has at least three cylinders and the at least one cylinder axis is three inline cylinder axes, and wherein a cylinder incline angle of the three inline cylinder axes to the longitudinal mid-plane is in the range from 10° to 55°.

4. The off-road vehicle according to claim 1, wherein the main front drive shaft defines a drive shaft axis, and wherein the drive shaft axis is at a drive shaft axis offset angle relative to the longitudinal mid-plane in a range from 2° to 10°.

5. The off-road vehicle according to claim 1, wherein the engine is entirely on a right or left side of the longitudinal midplane, and wherein the off-road vehicle further comprises:
a fuel tank having a fuel tank centroid positioned on an opposite right or left side of the longitudinal midplane as the engine; and
a battery having a battery centroid positioned on the opposite right or left side of the longitudinal midplane as the engine.

6. The off-road vehicle of claim 1, wherein the CVT comprises:
a driving pulley rotating about a driving pulley axis, the driving pulley receiving torque from the crankshaft of the engine;
a driven pulley rotating about a driven pulley axis, the driven pulley delivering torque to the gear assembly; and
a CVT belt or chain coupled to the driving pulley and the driven pulley and able to deliver torque from the driving pulley to the driven pulley at a variable speed ratio;
wherein a CVT mid-plane is defined as a plane parallel to the longitudinal midplane and spaced equally between the driving pulley axis and the driven pulley axis; and
wherein the CVT mid-plane is on the same right or left side of the longitudinal midplane as the engine.

7. The off-road vehicle according to claim 1, wherein the engine, the CVT and the gear assembly are jointly assembled as a prime mover assembly, wherein the gear assembly is positioned rearward of the CVT, and wherein at least part of the main front drive shaft extends under the CVT in plan view.

8. The off-road vehicle according to claim 7, wherein the prime mover assembly has a prime mover assembly length, wherein a mount area space is defined as being behind a front extent of the rear wheels and in front of a rear extent of the rear wheels, wherein the engine, the CVT and the gear assembly are each at least partially mounted in the mount area space, and wherein 28 to 80% of the prime mover assembly length is within the mount area space.

9. The off-road vehicle according to claim 8, wherein the CVT is positioned rearward of the engine.

10. The off-road vehicle according to claim 1, wherein the engine, the CVT and the gear assembly are assembled as a prime mover assembly, wherein the CVT is positioned rearward of the engine.

11. The off-road vehicle according to claim 10, wherein the prime mover assembly has a prime mover assembly length, wherein a mount area space is defined as being behind a front extent of the rear wheels and in front of a rear extent of the rear wheels, wherein the engine, the CVT and the gear assembly are each at least partially mounted in the mount area space, and wherein 40 to 100% of the prime mover assembly length is within the mount area space.

12. An off-road vehicle having a four wheel drive mode comprising:
a frame;
a side-by-side seating area supported by the frame;
a plurality of wheels supporting the frame through a suspension, the plurality of wheels including at least two front wheels and at least two rear wheels, the frame and the plurality of wheels defining a longitudinal mid-plane of the off-road vehicle;
an engine supported by the frame entirely on a right or left side of the longitudinal mid-plane, the engine comprising a plurality of cylinders driving a longitudinally-extending crankshaft;
a continuously variable transmission (CVT) connected to the engine and receiving torque from the crankshaft, the CVT being positioned in front or behind the engine and extending across the longitudinal mid-plane;
a gear assembly connected to the CVT and receiving torque from the CVT, the gear assembly being positioned in front or behind the CVT, the gear assembly having a gear assembly centroid positioned on an opposite right or left side of the longitudinal mid-plane as the engine; and
a drive train supported by the frame and delivering torque from the gear assembly to the front and rear wheels at least while the off-road vehicle is in the four-wheel drive mode, the drive train comprising:
a front differential extending across the longitudinal mid-plane and able to provide torque to the front wheels for locomotion of the off-road vehicle, the front differential being forward of the engine;
a rear differential extending across the longitudinal mid-plane and able to provide torque to the rear wheels for locomotion of the off-road vehicle, the rear differential being at least partially rearward of the engine; and
one or more drive line components delivering torque longitudinally from the gear assembly to the front differential, the drive line components including a main front drive shaft extending at least partially under the side-by-side seating area.

13. The off-road vehicle according to claim 12, wherein neither the main front drive shaft nor any other of the drive line components delivering torque from the gear assembly to the front differential extend under the engine in plan view.

14. The off-road vehicle according to claim 1, wherein the engine has at least three cylinders with three inline cylinder axes which are inclined relative to the longitudinal mid-plane, with a cylinder incline angle of the three inline cylinder axes to the longitudinal mid-plane is in the range from 10°to 55°.

15. The off-road vehicle according to claim 14, wherein the main front drive shaft defines a drive shaft axis, and wherein the drive shaft axis is at a drive shaft axis offset angle relative to the longitudinal mid-plane in a range from 2° to 10°.

16. The off-road vehicle according to claim 12, wherein the engine, the CVT and the gear assembly are jointly assembled as a prime mover assembly, and wherein the drive train further comprises a rear half shaft extending from the rear differential under the engine in plan view to one of the rear wheels.

17. The off-road vehicle according to claim 16, wherein the prime mover assembly has a prime mover assembly length, wherein a mount area space is defined as being behind a front extent of the rear wheels and in front of a rear extent of the rear wheels, wherein the engine, the CVT and the gear assembly are each at least partially mounted in the mount area space, and wherein 40 to 100% of the prime mover assembly length is within the mount area space.

18. The off-road vehicle according to claim 17, wherein the CVT is positioned behind the engine, and wherein the gear assembly is positioned in front of the CVT.

19. The off-road vehicle according to claim 17, wherein the CVT is positioned in front of the engine, and wherein the gear assembly is positioned behind the CVT.

20. The off-road vehicle according to claim 12, wherein the CVT comprises:
a driving pulley rotating about a driving pulley axis, the driving pulley receiving torque from the crankshaft of the engine;
a driven pulley rotating about a driven pulley axis, the driven pulley delivering torque to the gear assembly; and
a CVT belt or chain coupled to the driving pulley and the driven pulley and able to deliver torque from the driving pulley to the driven pulley at a variable speed ratio;
wherein a CVT mid-plane is defined as a plane parallel to the longitudinal midplane and spaced equally between the driving pulley axis and the driven pulley axis; and
wherein the CVT mid-plane is on the same right or left side of the longitudinal midplane as the engine.
